(19) United States
(12) Patent Application Publication
(10) Pub. No.: US 2005/0039009 A1
(43) Pub. Date: Feb. 17, 2005

(54) Web management system and method based on authentication

(76) Inventors: Fei Zhou, Shenzhen (TW); Tang He, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/834,455

(22) Filed: Apr. 28, 2004

(30) Foreign Application Priority Data
Jul. 25, 2003 (TW) 92120352

(51) Int. Cl. H04L 9/00

(52) U.S. Cl. 713/170

(57) ABSTRACT

A web management system (10) includes a plurality of clients (11) for entering requests for web management, a web application (12) and a function module (13). The web application includes a web server (121) for authenticating the clients, a configuration manager (125) for performing the web management according to the requests, and a common gateway interface (123) for interaction of the web server and the configuration manager. The web server stores authentication information on the clients. The function module provides support for the configuration manager to perform the web management. A related web management method is also disclosed.

### BACKGROUND OF THE INVENTION

1. Field of the Invention

The present invention relates to web management systems and methods, and particularly to web management systems and methods based on authentication.

2. Background of the Invention

With the widespread application of electronic communication networks, it is becoming popular to review information in a remote host employing the electronic communication networks and to configure the information according to current needs. China Patent Application No. 1359063A discloses a selective progressive model download method under a global information network environment. Referring to FIG. 4, the method is characterized by a progressive model that is stored in a material library 43 under a global information network servo device 42 in the form of common material library, and by LOD IDs (Level of Detail Identifications) of sections of the progressive model which can be used as a main key for accessing of said material library 43 by a client 41. Existing service programs in the global information network servo device 42 can be used to obtain required progressive model material from said material library 43 by utilizing the delivered HTTP requirement with the LOD ID. Such programs include CGI (Common Gateway Interface), ASP (Active Server Page), and PHP (Hypertext Preprocessor). Therefore under the condition of an existing global information network structure, the method does not require new servo device programs to be added. Instead, the method only uses the existing service programs to implement downloading of progressive models.

Although the above-mentioned selective progressive model download method is relatively efficient for downloading of information from the remote host, it does not provide a security mechanism for authenticating clients who want to download the information. In particular, web configuration and management should be performed only by users having appropriate authentication. Therefore, a web management system and a corresponding method based on authentication are required.

### SUMMARY OF THE INVENTION

Accordingly, an objective of the present invention is to provide a web management system based on authentication.

Another objective of the present invention is to provide a web management method based on authentication.

In order to accomplish the above-mentioned first objective, a preferred web management system comprises a plurality of clients for entering requests for web management, a web application and a function module. The web application includes a web server for authenticating the clients, a configuration manager for performing the web management according to the requests, and a common gateway interface (CGI) for interaction of the web server and the configuration manager. The web server stores authentication information on the clients. The function module provides support for the configuration manager to perform the web management.

In order to accomplish the above-mentioned second objective, a preferred web management method comprises the steps of: (i) sending a request packet via a client for web management, the request packet accompanied with authentication information and an address of the client; (ii) determining whether the request packet meets predetermined authentication requirements; and (iii) performing web management on the support of a function module if the request packet meets the predetermined authentication requirements; or (iv) sending a demand to the client for correct authentication data if the request packet does not meet the predetermined authentication requirements. The determining step further comprises the steps of: receiving the request accompanied by the authentication information and the address of the client; determining whether the address of the client is in an address array, the address array storing addresses of clients that have passed authentication; and passing the request if the address of the client is in the address array; or determining whether it is a first time request for the client if the address of the client is not in the address array; and sending a demand for correct authentication data if it is not a first time request for the client; or determining whether the authentication information is correct if it is a first time request for the client; and sending a demand for correct authentication data if the authentication information is not correct; or adding the address of the client to the address array, and passing the request if the authentication information is correct.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of software infrastructure of a web management system in accordance with a preferred embodiment of the present invention;

FIG. 2 is a flow chart of a web management method based on authentication in accordance with the preferred embodiment of the present invention;

FIG. 3 is a flow chart of determining whether a request meets authentication requirements in accordance with the preferred embodiment of the present invention; and

FIG. 4 is a block diagram of an application environment of a conventional selective progressive model download method.

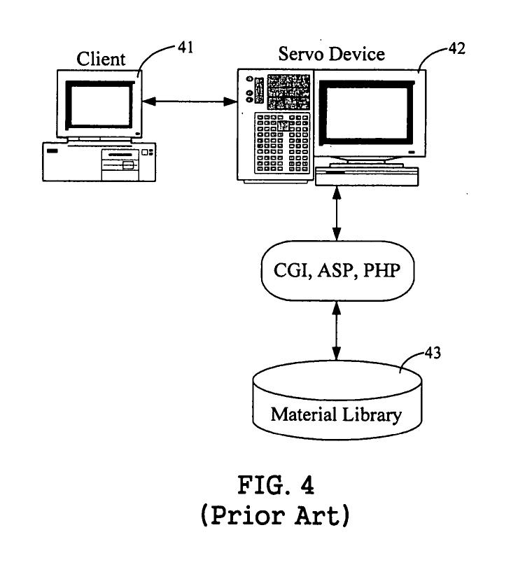

### DETAILED DESCRIPTION OF PREFERRED EMBODIMENTS OF THE INVENTION

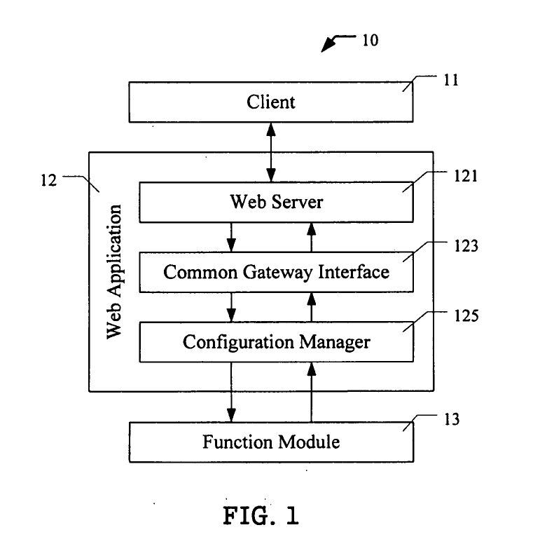

FIG. 1 illustrates a schematic diagram of software architecture of a web management system 10 in accordance with the preferred embodiment of the present invention. The web management system 10 comprises a plurality of clients 11 (only one shown), a web application 12, and a function module 13. The clients 11 provide users with interfaces for interacting with the web management system 10 of the present invention, such as by way of inputting requests to and receiving information returned from the web management system 10. The web application 12 comprises a web server 121, a common gateway interface (CGI) 123, and a configuration manager 125. The function module 13 provides necessary support for the web application 12. Such support includes providing various functional programs, which enable the web application 12 to perform relevant operations, such as web management, retrieval of web information and so on.

In the described embodiment, the web server 121 is based on an HTTP server such as a thttpd-2020c server, and stores authentication information on all clients 11. In the preferred embodiment, the web server 121 is provided for authenticating the clients 11, and can be modified. It is mainly authentication information on the clients 11 which is modified in the web server 121. The common gateway interface 123 is a standard for interfacing external applications with information servers, such as the web server 121. A CGI program is executed in real time, and therefore can output dynamic information. In the preferred embodiment, the common gateway interface 123 is provided for interaction of the web server 121 and the configuration manager 125. The configuration manager 125 is used for performing web management according to the requests input from the clients 11, based on the support of the function module 13. The web management may be configurations or modifications to web elements, or other similar operations.

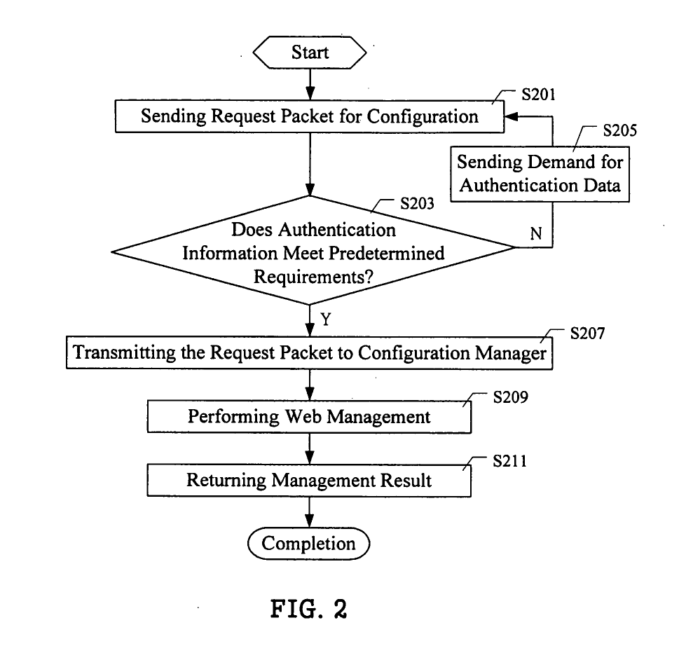

FIG. 2 is a flow chart of a web management method based on authentication in accordance with a preferred embodiment of the present invention. At step S201, a client 11 sends a request packet for web management. In the preferred embodiment, the request packet is accompanied with authentication information and an address of the client 11. At step S203, the web server 121 determines whether the request packet meets predetermined authentication requirements. The predetermined authentication requirements may be authentication information on the client, the address of the client, or other authentication mechanisms. If the request packet does not meet the authentication requirements, at step S205, the web server 121 sends a demand to the client 11 for correct authentication data that can meet the predetermined authentication requirements. Otherwise, at step S207, the web server 121 sends the request packet to the configuration manager 125 by way of the CGI 123. At step S209, the configuration manager 125 performs web management with the support of the function module 13. At step S211, the configuration manager 125 returns management results to the client 11 by way of the CGI 123 and the web server 121.

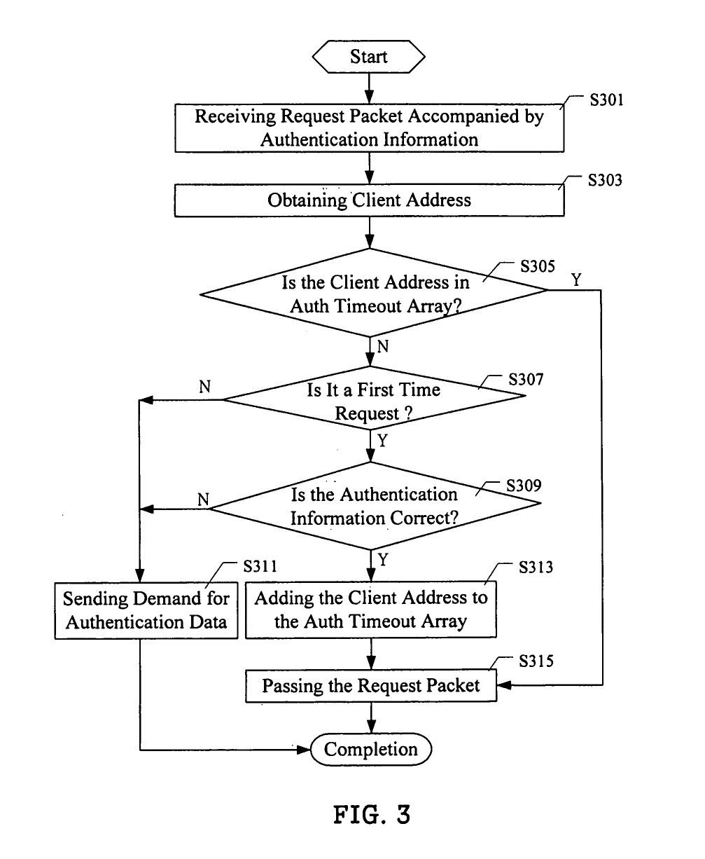

FIG. 3 is a flow chart of details of step S203 of FIG. 2, namely determining whether the request packet meets the authentication requirements. At step S301, the web server 121 receives the request packet accompanied by the authentication information and the address of the client 11. At step S303, the web server 121 retrieves the authentication information and the address of client. At step S305, the web server 121 determines whether the client address is in an auth timeout array. In the preferred embodiment, the auth timeout array records addresses of those clients 11 that have passed authentication by the web server 121. If the client address is in the auth timeout array, at step S315, the web server 121 passes the request packet and transmits it to the configuration manager 125 directly. If the client address is not in the auth timeout array, at step S307, the web server 121 determines whether it is a first time request by the client 11. If it is not a first time request, the web server 121 indicates that the client 11 does not have correct authentication data to pass the web server 121. Therefore, at step S311, the web server 121 sends a demand for correct authentication data to the client 11. If it is a first time request, at step S309, the web server 121 determines whether the authentication information is correct. If the authentication information is not correct, at step S311, the web server 121 sends a demand for correct authentication data to the client 11. If the authentication information is correct, at step S313, the web server 121 adds the address of the client 11 to the auth timeout array. Thus, the client 11 can pass the web server 121 with the same address on a later occasion. At step S315, the web server 121 passes the request packet and transmits it to the configuration manager 125.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

1. A web management system based on authentication, the system comprising:
at least one client, which provides an interface for users to enter requests, the requests being for web management;
a web application for authenticating said client, and performing the web management according to the requests; and
a function module for providing support to the web application.

2. The web management system as recited in claim 1, wherein the web application comprises a web server for authenticating said client.

3. The web management system as recited in claim 2, wherein the web server stores authentication information on said client.

4. The web management system as recited in claim 2, wherein the web application comprises a configuration manager for performing the web management.

5. The web management system as recited in claim 4, wherein the web application comprises a common gateway interface for interaction of the web server and the configuration manager.

6. A web management method based on authentication, the method comprising the steps of:
(a) entering a request for web management via a client;
(b) determining whether the request meets at least one predetermined authentication requirement; and
(c) performing web management according to the request if the request meets said predetermined authentication requirement.

7. The web management method as recited in claim 6, further comprising the step of:
sending a demand for correct authentication data to the client if the request does not meet said predetermined authentication requirement.

8. The web management method as recited in claim 6, further comprising the following step after step (c):
returning a management result to the client.

9. The web management method as recited in claim 6, wherein the request is accompanied by authentication information and an address of the client.

10. The web management method as recited in claim 9, wherein step (b) further comprises the steps of:
(b1) receiving the request accompanied by the authentication information and the address of the client;
(b2) determining whether the address of the client is in an address array, the address array storing addresses of clients that have passed authentication, and passing the request if the address of the client is in the address array; or
(b3) determining whether the authentication information is correct if the address of the client is not in the address array; and
(b4) sending a demand for correct authentication data to the client if the authentication information is not correct; or
(b5) passing the request if the authentication information is correct.

11. The web management method as recited in claim 10, further comprising the steps of:
determining whether it is a first time request for the client if the address of the client is not in the address array; and
sending a demand for correct authentication data if it is not a first time request for the client; or
adding the address of the client to the address array; and
passing the request.

12. A process of determining whether a request packet meets the authentication requirements, comprising steps of:
(a) receiving a request packet accompanied by authentication information;
(b) obtaining a client address;
(c) determining whether the client address in an auth timeout array;
(d) if yes for step (c), passing the request packet to final completion, or
(e) if no for step (c), determining whether it is a first time for said request packet;
(f) if yes for step (e), further determining whether the authentication information is correct;
(g) if yes for step (f), adding the client address to the auth timeout array and passing the request packet to the final completion; and
(h) if no for step (e) or (f), sending a demand for authentication data to the final completion.
